(19) United States
(12) Patent Application Publication
(10) Pub. No.: US 2024/0280667 A1
(43) Pub. Date: Aug. 22, 2024

(54) RADAR SIGNAL PROCESSING DEVICE, RADAR SIGNAL PROCESSING METHOD, AND NON-TRANSITORY COMPUTER READABLE MEDIUM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Masanari TAKAKI, Nisshin-shi (JP)

(21) Appl. No.: 18/421,447

(22) Filed: Jan. 24, 2024

(30) Foreign Application Priority Data
Feb. 17, 2023 (JP) 2023-023426

(51) Int. Cl. G01S 7/40; G01S 13/58; G01S 13/931

(52) U.S. Cl. CPC G01S 7/4021; G01S 13/582; G01S 13/931; G01S 13/589

(57) ABSTRACT

A radar signal processing device includes an acquirer, pre-segment generator, and a segment generator. The acquirer acqu.ires ranging point information including position information and speed information at each of ranging points obtained by irradiating radar waves. The pre-segment generator generates a pre-segment by grouping the ranging points as a set of the ranging points based on the acquired ranging point information from the acquirer. The segment generator generates a composite segment by combining the ranging points from a first pre-segment with the ranging points from a second pre-segment as a set of the ranging points based on a positional relationship between the first pre-segment and the second pre-segment. The first pre-segment is one of pre-segments generated by the pre-segment generator. The second pre-segment is another one of the pre-segments generated by the pre-segment generator.

### CROSS REFERENCE TO RELATED APPLICATION

This application is based on and claims the benefits of priority of Japanese Patent Application No. 2023-023426 filed on Feb. 17, 2023. The entire disclosure of which is incorporated herein by reference.

### TECHNICAL FIELD

The present invention relates to a radar signal processing device, a radar signal processing method, and a non-transitory computer readable medium storing a computer program.

### BACKGROUND

A radar signal processing device detects many measurement points from an entire vehicle when the radar signal processing device detects, for example, a traveling vehicle using a radar.

### SUMMARY

According to at least one embodiment, a radar signal processing device includes an acquirer, pre-segment generator, and a segment generator. The acquirer acquires ranging point information including position information and speed information at each of ranging points obtained by irradiating radar waves. The pre-segment generator generates a pre-segment by grouping the ranging points as a set of the ranging points based on the acquired ranging point information from the acquirer. The segment generator generates a composite segment by combining the ranging points from a first pre-segment with the ranging points from a second pre-segment as a set of the ranging points based on a positional relationship between the first pre-segment and the second pre-segment. The first pre-segment is one of pre-segments generated by the pre-segment generator. The second pre-segment is another one of the pre-segments generated by the pre-segment generator.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a schematic configuration of a radar system including a target recognition device.

FIG. 2 is a block diagram illustrating an example of a functional configuration of the target recognition device illustrated in FIG. 1.

FIG. 3 is a schematic diagram illustrating an outline of an operation of the target recognition device illustrated in FIG. 1 together with an example of a recognition target.

FIG. 4 is a schematic diagram illustrating an outline of an operation of the target recognition device illustrated in FIG. 1 together with another example of a recognition target.

FIG. 5 is a schematic diagram illustrating how a composite segment is generated from pre-segments in FIG. 4.

FIG. 6 is a flowchart illustrating an outline of an operation of the target recognition device illustrated in FIG. 1.

FIG. 7 is a flowchart illustrating an outline of an operation of the target recognition device illustrated in FIG. 1.

FIG. 8 is a perspective view illustrating still another example of a recognition target in FIG. 1.

FIG. 9 is a schematic diagram illustrating an outline of an operation of the target recognition device illustrated in FIG. 1.

### DETAILED DESCRIPTION

To begin with, examples of relevant techniques will be described.

A radar signal processing device according to a comparative example includes a velocity vector calculator, a grouping processor, an average-relative velocity vector calculator, and a distance corrector. The velocity vector calculator calculates a composite relative velocity vector of a virtual object including each measurement point based on each relative velocity vector of measurement points detected by one or a plurality of radars. The grouping processor groups virtual objects, which have the same calculated composite relative velocity vector of virtual objects, as real objects. The average-relative velocity vector calculator calculates an average-relative velocity vector by averaging the combined relative velocity vectors of the grouped real objects. The distance correction unit corrects a distance of each measurement point based on the calculated average-relative velocity vector. The measurement point may also be referred to as a measurement point or a ranging point.

A radar signal processing device detects many measurement points from an entire vehicle when the radar signal processing device detects, for example, a traveling vehicle using a radar. In particular, at a measurement point of a part, such as wheels, which moves differently from a movement of a vehicle body, a speed different from that at the measurement point of the vehicle body is detected. A measurement point that has a velocity component that is partially different from the surrounding velocity component is called a micro-Doppler point. Since the micro-Doppler point has a velocity far away from an overall velocity average value, a radar signal processing device may erroneously treat the micro-Doppler point as an independent target. More specifically, for example, according to the radar signal processing device of the comparative example, a vehicle body and wheels may be determined as different targets.

In contrast to the comparative example, according to a radar signal processing device, a radar signal processing method, and a radar signal processing program of the present disclosure, excessive divisions of a target based on micro-Doppler can be avoided.

According to an aspect of the present disclosure, a radar signal processing device includes an acquirer, pre-segment generator, and a segment generator. The acquirer acquires ranging point information including position information and speed information at each of ranging points obtained by irradiating radar waves. The pre-segment generator generates a pre-segment by grouping the ranging points as a set of the ranging points based on the acquired ranging point information from the acquirer. The segment generator generates a composite segment by combining the ranging points from a first pre-segment with the ranging points from a second pre-segment as a set of the ranging points based on a positional relationship between the first pre-segment and the second pre-segment. The first pre-segment is one of pre-segments generated by the pre-segment generator. The second pre-segment is another one of the pre-segments generated by the pre-segment generator.

### Embodiment

Hereinafter, embodiments of the present disclosure will be described with reference to the drawings. If descriptions of various modifications applicable to one embodiment are sequentially inserted in the middle of a series of descriptions regarding the embodiment, understanding of the embodiment may be hindered. Therefore, the modifications will be described not in the middle of the series of descriptions regarding the embodiment, but collectively described after the series of descriptions.

### Overall System Configuration

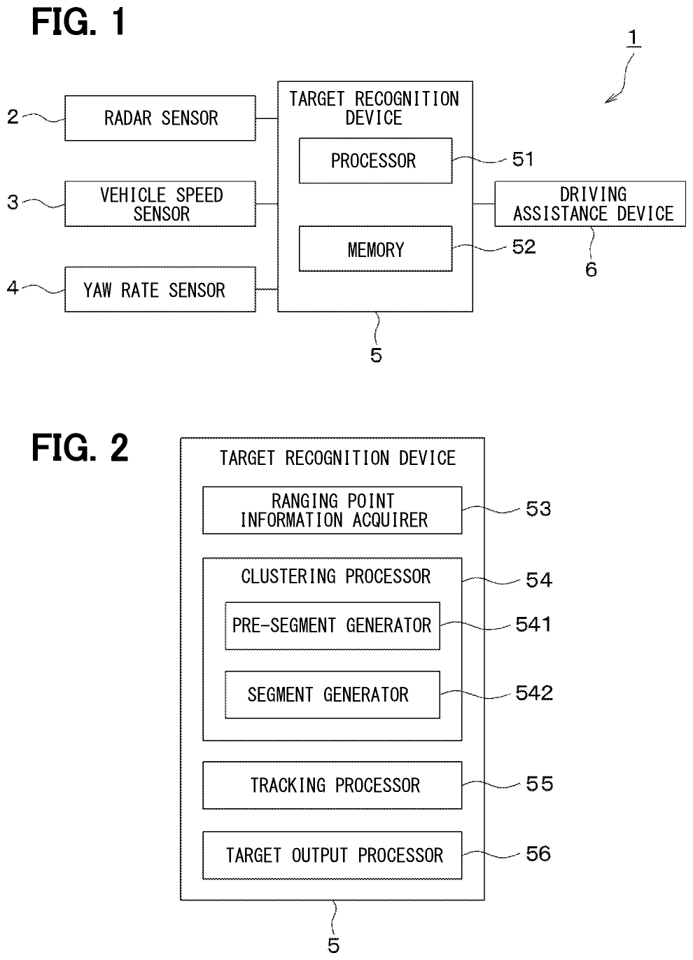

As shown in FIG. 1, an in-vehicle system 1 mounted on a vehicle such as an automobile traveling on a road controls an operation of the vehicle. Hereinafter, the vehicle on which the in-vehicle system 1 is mounted may be referred to as a “subject vehicle”. The “operation of the vehicle” mentioned here is, for example, a driving control operation, an information presentation operation or a warning operation for an occupant, or the like. That is, the in-vehicle system 1 detects various targets including at least other vehicles, which are vehicles other than the subject vehicle, using at least a part of a surrounding area of the subject vehicle as a detection area, and provides the detection result for vehicle control such as warning to an occupant of the subject vehicle and driving assistance.

More specifically, in the present embodiment, the in-vehicle system 1 includes a radar sensor 2, a vehicle speed sensor 3, a yaw rate sensor 4, a target recognition device 5, and a driving assistance device 6. That is, the in-vehicle system 1 has a configuration as a so-called driving automation system. The “driving automation system” is a superordinate concept including an automated driving system and a driving assistance system. The “automated driving” refers to the driving automation level corresponding to levels 3 to 5 in which the driving automation system is in charge of or executes all dynamic driving tasks in the standard “SAE J3016” published by SAE International. The “dynamic driving tasks” are all operational and tactical functions that need to be executed in real time when a vehicle is operated in road traffic, excluding strategic functions. The “strategic functions” are trip scheduling, waypoint selection, and the like, or more specifically, include determining or selecting “whether to go, and when, where, and how to go”. The “driving assistance” refers to the driving automation level corresponding to levels 1 to 2 in the standard “SAE J3016”, in which the driving automation system continuously performs a longitudinal vehicle motion control subtask and/or a lateral vehicle motion control subtask of dynamic driving tasks in a specific limited area. The vehicle motion control subtasks include, for example, start, acceleration, deceleration, braking, stop, steering, shift range change, and the like. That is, the “driving assistance” includes, for example, at least one of a lane keeping function, a lane change assistance function, an automatic lane change function, a preceding vehicle following function, a collision avoidance function, and the like.

The radar sensor 2 observes a frequency shift due to the Doppler effect to obtain a relative moving speed and displacement of the target being observed. Therefore, the radar sensor 2 is configured as a so-called Doppler radar. The radar sensor 2 is configured to be able to detect a direction of a reflected wave. More specifically, in the present embodiment, the radar sensor 2 has a configuration as a laser radar sensor (that is, a LiDAR sensor) capable of acquiring a Doppler velocity. The LIDAR stands for Light Detection and Ranging/Laser Imaging Detection and Ranging.

The vehicle speed sensor 3 detects a vehicle speed of the subject vehicle. The yaw rate sensor 4 detects a yaw rate acting on the subject vehicle. In addition, the in-vehicle system 1 includes various sensors (not shown) for example, a camera, an accelerator position sensor, an acceleration sensor, and the like, for detecting information and physical quantities related to a driving operation state and a driving behavior of the subject vehicle.

The target recognition device 5 is connected to various sensors provided in the in-vehicle system 1, including the radar sensor 2, the vehicle speed sensor 3, and the yaw rate sensor 4, via an in-vehicle communication line. The target recognition device 5 recognizes a target around the subject vehicle based on information or signals acquired by these sensors. That is, the target recognition device 5 as a radar signal processing device in the present invention executes a target recognition operation by processing a radar signal which is measurement information output from the radar sensor 2. The target recognition device 5 is connected to the driving assistance device 6 via the in-vehicle communication line so as to output a target recognition result to the driving assistance device 6. The driving assistance device 6 executes a vehicle control operation such as a warning operation or a collision avoidance operation based on the target recognition result received from the target recognition device 5.

The target recognition device 5 includes a processor 51 and a memory 52. The processor 51 has a CPU or an MPU. The CPU is an abbreviation for Central Processing Unit. The MPU is an abbreviation for Micro Processing Unit. The memory 52 holds a program to be executed by the processor 51 and various data such as a lookup table required when the program is executed. The memory 52 is, for example, a non-transitory tangible storage medium. More specifically, the memory 52 includes at least one of a ROM, a flash memory, a magnetic disk, and the like. The ROM is an abbreviation for Read-Only Memory. In the target recognition device 5, the processor 51 reads the program from the memory 52 and executes a target detection process and other processes.

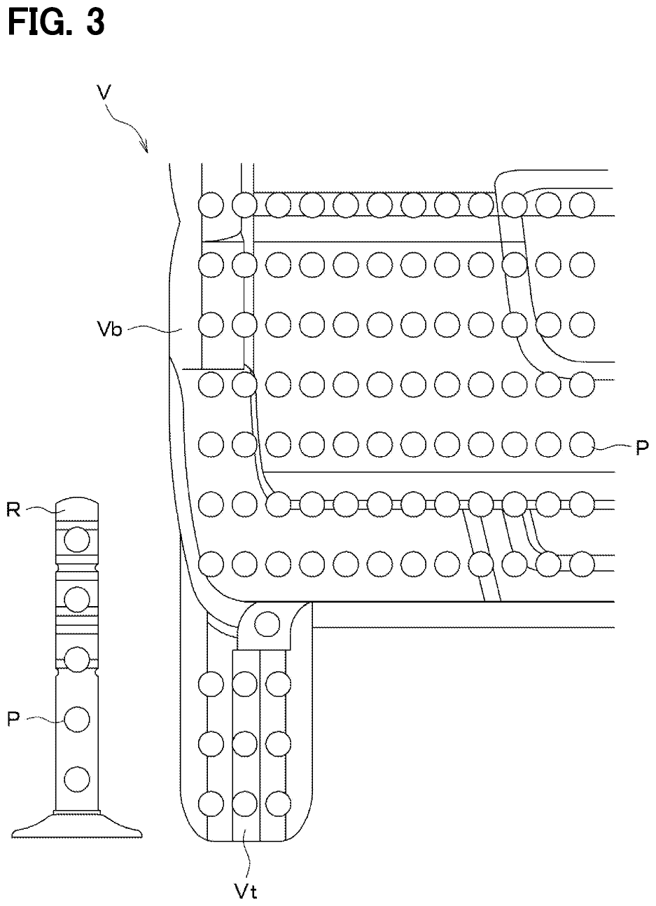

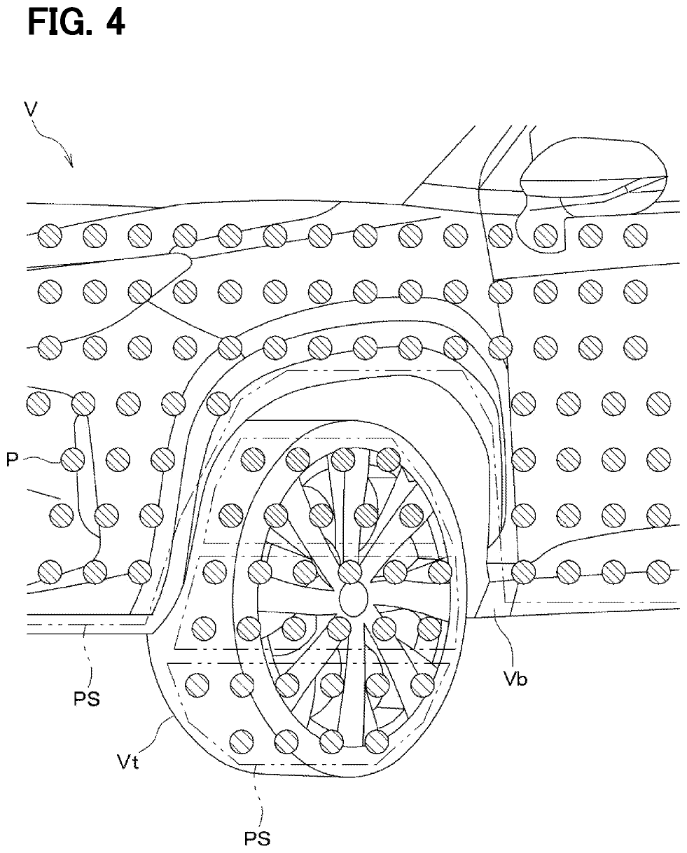

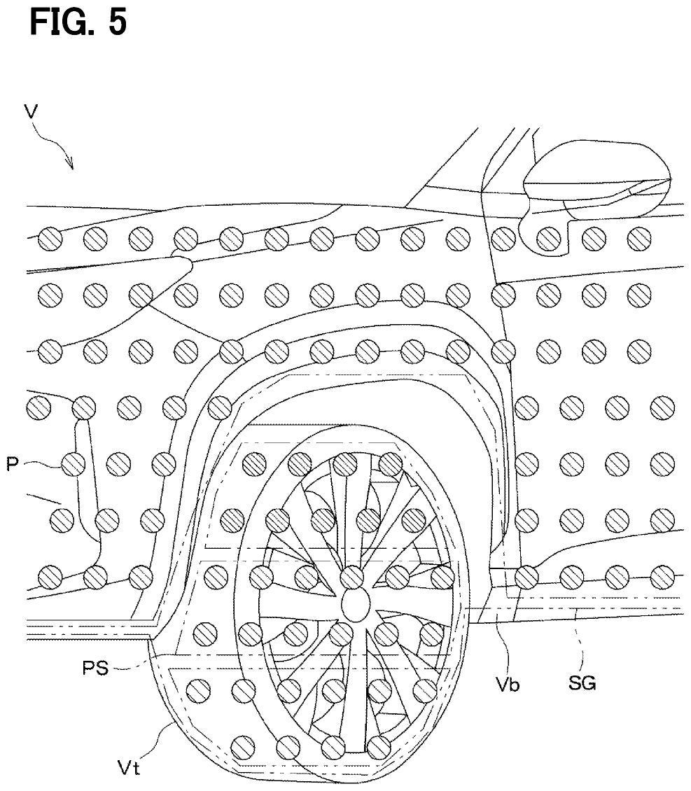

FIG. 2 shows a functional configuration implemented in the target recognition device 5 by the processor 51 reading and executing a target recognition program from the memory 52. FIG. 3 shows a state of detection of ranging points P in a target including another vehicle V traveling in front of the subject vehicle traveling forward in the same direction as the subject vehicle. FIGS. 4 and 5 are enlarged views illustrating the detection of the ranging points P in a vicinity of a left front wheel of the other vehicle V approaching the subject vehicle. The ranging point P is a point at which a radar wave is estimated to be reflected on the target, and is also referred to as a “measurement point” or a “reflection point”. As shown in FIG. 2, the target recognition device 5 includes a ranging point information acquirer 53, a clustering processor 54, a tracking processor 55, and a target output processor 56 as a functional configuration realized by executing a program. Hereinafter, details of each functional configuration of the target recognition device 5 according to the present embodiment will be described with reference to FIGS. 2 to 5.

The ranging point information acquirer 53 acquires ranging point information output from the radar sensor 2. The ranging point information includes position information and speed information at the ranging points P acquired by irradiation of radar waves. The speed information is a relative velocity of the ranging point P with respect to the subject vehicle, and is represented by a negative value when the ranging point P approaches the subject vehicle and by a positive value when the ranging point P moves away from the subject vehicle. The position information can be expressed by polar coordinates for specifying a position by a distance and an azimuth to the ranging point P with reference to the subject vehicle or orthogonal coordinates set with reference to the subject vehicle. More specifically, the ranging point information acquirer 53 holds the ranging point information over time for each measurement cycle.

The clustering processor 54 executes a clustering process on the ranging point information acquired by the ranging point information acquirer 53. The clustering process is a process of grouping the ranging points P detected in a certain measurement cycle and defining ranging points P belonging to the same group as those reflected by one target. Details of the clustering process according to the present embodiment will be described later. The tracking processor 55 executes a tracking process for tracking a target in time series by using a tracking processing method such as a Kalman filter method or an α-β filtering method. The target output processor 56 outputs a target recognition result including a processing result by the tracking processor 55 to the driving assistance device 6.

In the present embodiment, the clustering processor 54 includes a pre-segment generator 541 and a segment generator 542. The pre-segment generator 541 groups ranging points P based on the ranging point information acquired by the ranging point information acquirer 53 to generate a pre-segment PS as a primary set of the ranging points P. More specifically, the pre-segment generator 541 generates the pre-segment PS under grouping conditions that the positions of the ranging points P are close to each other and the speed difference is small, which is a clustering method. The segment generator 542 generates the segment SG to be subjected to the tracking process by the tracking processor 55 based on the pre-segment PS generated by the pre-segment generator 541.

In the present embodiment, the segment generator 542 generates the segment SG as a set of ranging points P included in the pre-segments PS when pre-segments PS satisfy a predetermined relationship in which it should be determined that the pre-segments PS belong to the same target. The segment SG including all the ranging points P included in the pre-segments PS satisfying the predetermined relationship, that is, the segment SG including the pre-segments PS is hereinafter referred to as a “composite segment”. On the other hand, in a case where a certain single pre-segment PS does not satisfy the condition for generating a composite segment with another pre-segment PS, the segment generator 542 sets the single pre-segment PS as the segment SG as it is. In the following description, for the sake of simplicity, two pre-segments PS are taken into consideration when determining whether to generate the composite segment. One of the two pre-segments PS is referred to as a “target pre-segment”, and the other is referred to as a “reference pre-segment”. The “target pre-segment” may also be referred to as a “first pre-segment”. The “reference pre-segment” may also be referred to as a “second pre-segment”.

More specifically, the “predetermined relationship” includes, for example, a positional relationship between the target pre-segment and the reference pre-segment. More specifically, the segment generator 542 generates the composite segment from the target pre-segment and the reference pre-segment on condition that the target pre-segment and the reference pre-segment satisfy all of the following four conditions. (1) The distance between the target pre-segment and the reference pre-segment is within a threshold. (2) The ranging points P included in the target pre-segment and the ranging points P included in the reference pre-segment are in a vertical relationship, or the target pre-segment surrounds the reference pre-segment. (3) The target pre-segment includes the ranging points P corresponding to the moving target. (4) A size of the reference pre-segment is within a threshold.

### Operation

Hereafter, a description will be given to the operations of the target recognition device 5 according to the present embodiment and an overview of a method and a program executed by the target recognition device 5 as well as an effect brought about by the present embodiment. In the following description, the target recognition device 5 having the above-described configuration, and the radar signal processing method and the radar signal processing program (a computer program product) executed by the target recognition device 5 may be collectively referred to simply as “the present embodiment”.

As shown in FIGS. 3 and 4, many ranging points P are detected from the entire other vehicle V when the other vehicle V traveling is detected using a radar. For example, there is a part that moves differently from a movement of the vehicle body Vb, such as a wheel Vt. At the ranging points P of such a portion, a speed different from that at the ranging points P of the vehicle body Vb is detected. Thus, the ranging point P having a velocity component partially different from that of the surroundings is referred to as a micro-Doppler point. For details of the micro-Doppler point, refer to Japanese Unexamined Patent Application Publication No. 2021-124422, Japanese Unexamined Patent Application Publication No. 2021-188922, and the like. Such a micro-Doppler point may have a speed greatly different from an average speed of the other vehicle body Vb. Therefore, according to the comparative example, such a micro-Doppler point may be erroneously processed as an independent target. More specifically, for example, according to the comparative example, a vehicle body Vb and a wheel Vt may be determined as different targets. Regarding this, even in the comparative example, the vehicle body Vb and the wheel Vt can be determined as the same target by loosening a speed threshold in the grouping. However, according to this, for example, as shown in FIG. 3, in a scene in which the other vehicle V is passing close to a rubber pole R which is a stopped target, a malfunction may occur in which the other vehicle V and the rubber pole R are erroneously determined as the same target.

Therefore, the inventors have focused on the following points. That is, for example, referring to FIG. 3, the vehicle body Vb is usually present above the wheel Vt. For this reason, there is a high probability that the ranging points P corresponding to the vehicle body Vb or the group thereof exists above the ranging points P corresponding to the wheel Vt or the group thereof. Contrary to this, the ranging points P or the group thereof should not exist above the ranging points P corresponding to the rubber pole R or the group thereof. Referring to FIG. 4, a side of the ranging points P corresponding to the wheel Vt or the group thereof is surrounded by the ranging points P corresponding to the vehicle body Vb or the group thereof.

Therefore, for a portion such as the wheel Vt which is included in the other vehicle V but at which a speed different from that of the vehicle body Vb is detected, the pre-segment PS or the ranging points P corresponding to the vehicle body Vb are present above the pre-segment PS corresponding to the portion. Alternatively, the pre-segment PS corresponding to such a portion is surrounded by the pre-segment PS corresponding to the vehicle body Vb or the ranging points P. Contrary to this, in a case of another target such as the rubber pole R close to the other vehicle V, the ranging points P and the pre-segment PS above the other target do not exist, and the ranging points P and the pre-segment PS surrounding the other target also do not exist.

Therefore, in the present embodiment, when pre-segments PS satisfy a predetermined relationship to be determined as belonging to the same target, a segment SG is generated as a set of ranging points P included in the pre-segments PS. That is, in the present embodiment, the pre-segments PS are integrated, combined, synthesized, or merged. Alternatively, the present embodiment connects the target pre-segment to the reference pre-segment. More specifically, in the present embodiment, the composite segment is generated based on the positional relationship between the pre-segments PS. For example, in the present embodiment, the composite segment is generated on a condition that a distance between the target pre-segment and the reference pre-segment is within a threshold and the ranging points P included in the target pre-segment and the ranging points P included in the reference pre-segment are in the vertical relationship. In the present embodiment, the composite segment is generated on condition that the target pre-segment surrounds the reference pre-segment. Further, in the present embodiment, the composite segment is generated on condition that the target pre-segment and the reference pre-segment are composed of the ranging points P corresponding to a moving target. Accordingly, erroneous recognition of different targets as the same target can be effectively reduced, while an excessive division of the target can be favorably reduced. More specifically, in a scene shown in FIG. 3, the excessive division between the set of the ranging points P corresponding to the wheels Vt and the set of the ranging points P corresponding to the vehicle body Vb can be reduced, while distinguishing the rubber poles R and the other vehicle V having different relative velocity with respect to the subject vehicle.

A specific example of generation of a composite segment will be described with reference to FIGS. 4 and 5. In these drawings, the speed information at each of the ranging points P is indicated by a density of hatching. More specifically, the darker the hatching, the higher the approaching speed to the subject vehicle. For example, as shown in FIG. 4, a substantially central portion of the wheel Vt in an up-down direction has a Doppler velocity substantially similar to that of the vehicle body Vb. Contrary to this, an upper portion of the wheel Vt in the up-down direction has a Doppler velocity higher than that of the vehicle body Vb. On the other hand, a lower portion of the wheel Vt in the up-down direction has a Doppler velocity smaller than that of the vehicle body Vb. Therefore, in a situation shown in FIG. 4, a pre-segment PS corresponding to the upper portion of the wheel Vt and a pre-segment PS corresponding to the lower portion of the wheel Vt are generated separately from a pre-segment PS corresponding to the vehicle body Vb by the pre-segment generation using the clustering method similar of the comparative example. The ranging point P corresponding to the substantially central portion of the wheel Vt may be a pre-segment PS separate from the pre-segment PS corresponding to the vehicle body Vb, but may be integrated with the pre-segment PS corresponding to the vehicle body Vb. Contrary to this, as shown in FIG. 5, the pre-segment PS corresponding to the vehicle body Vb and each pre-segment PS corresponding to the wheel Vt are integrated as one segment SG, that is, a composite segment.

However, for example, the Doppler velocity may be observed in a tree. Therefore, for example, a situation of erroneous recognition in which a pedestrian under a tree is erroneously combined with the tree is assumed. Therefore, in the present embodiment, the composite segment is generated on condition that a size of the reference pre-segment is within a threshold. More specifically, for example, a height of a pedestrian is about 1.8 m for an adult and about 1.15 m for a child. On the other hand, an outer diameter of the wheel Vt of a bus or a truck is about 1 m. Therefore, in the present embodiment, the threshold of the reference pre-segment for connecting the reference pre-segment to the target pre-segment is set to a dimension corresponding to the outer diameter of the wheel Vt of the bus or truck, for example, a predetermined dimension of 1 m square or less. As a result, the combination of the tree and the pedestrian can be effectively reduced when the erroneous speed information is obtained from the tree.

As described above, in the present embodiment, when the ranging points P are grouped as the ranging points P of the same target, the ranging points P whose speeds and distances are close to each other are not simply grouped, but the ranging points P are grouped even if the speeds are not close to each other in a case where peripheral relationship of the ranging points P can be determined as the same target. Such the peripheral relationship indicates that even if there is a speed difference, the objects exist in a vertical relationship or are surrounded in a lateral direction. An upper portion and a surrounding portion need to be determined as a moving object, for example, corresponding to the vehicle body Vb in the case of a vehicle.

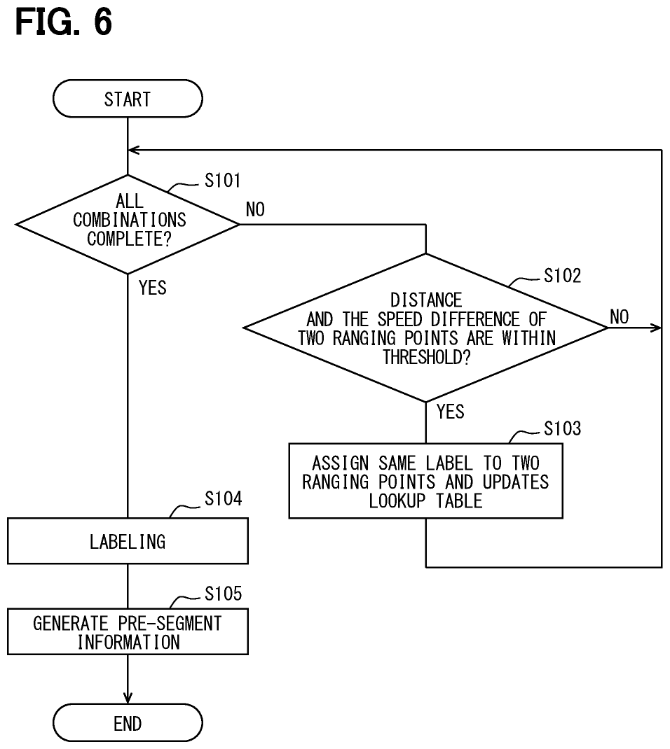

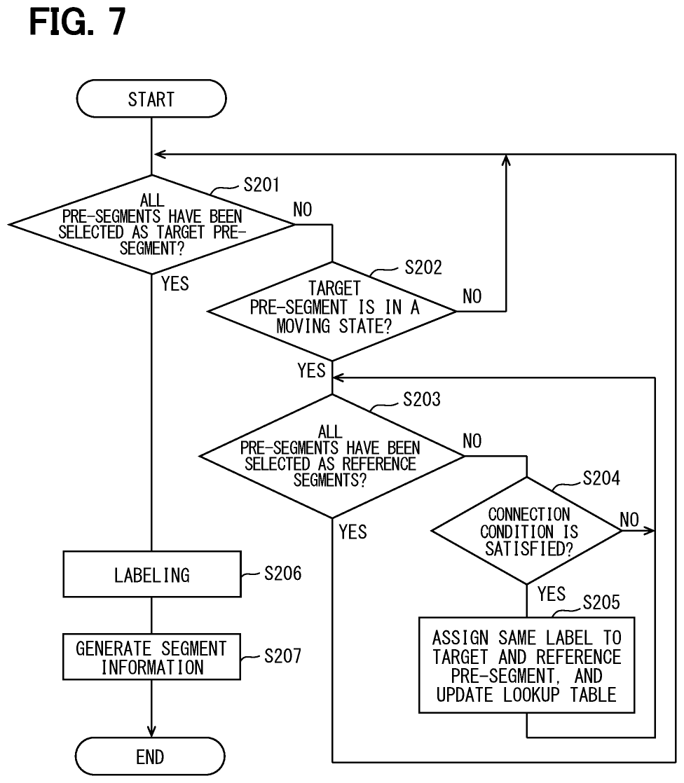

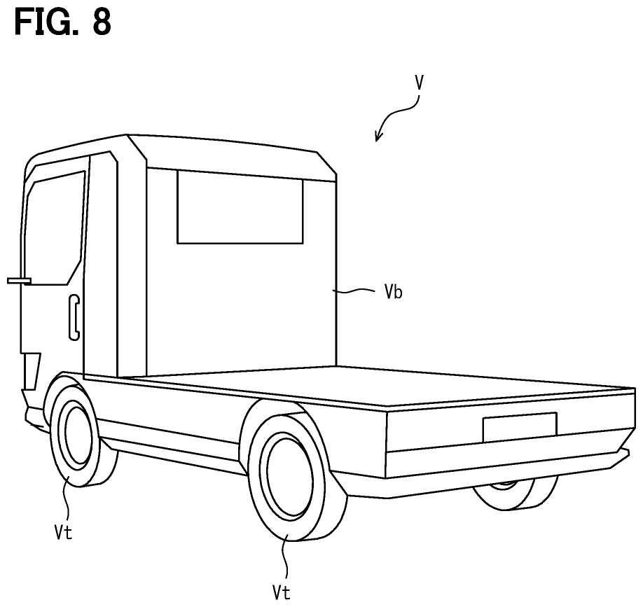

FIG. 6 is a flowchart illustrating a specific example of processing in the pre-segment generator 541, that is, pre-segment generation processing. FIG. 7 is a flowchart illustrating a specific example of processing in the segment generator 542, that is, segment generation processing. In these drawings, “S” is an abbreviation for “step”. Hereinafter, a specific example of the processing in the clustering processor 54, that is, the clustering process will be described with reference to the flowcharts illustrated in FIGS. 6 and 7.

The processor 51 reads the target recognition program (that is, a program including the radar signal processing program) according to the present embodiment from the memory 52 and executes the target recognition program to perform the pre-segment generation process illustrated in FIG. 6. In the pre-segment generation processing, first, in step S101, the processor 51 determines whether connection comparison has been performed for all combinations of the ranging points P. The “connection comparison” refers to comparing the ranging point information at two ranging points P in order to determine whether to group, that is, whether to form one pre-segment PS. When there is a combination of the ranging points P for which the connection comparison has not been completed, that is, when the determination in step S101 is “NO”, the processor 51 causes the processing to proceed to step S102.

In step S102, the processor 51 determines whether the distance and the speed difference between the ranging points P are within a threshold in the combination of the two ranging points P selected this time. When the two ranging points P are close to each other and the determination result in step S102 is “YES”, the processor 51 executes the process of step S103 and then returns the process to step S101. In step S103, the processor 51 assigns the same label to the two ranging points P selected this time, and updates the lookup table. On the other hand, when the determination in step S102 is “NO”, the processor 51 returns the processing to step S101. Then, when the determination in step S101 is “NO” for two ranging points P of a combination different from the previous combination and the process proceeds from step S102 to step S103 again, a label different from the previous label is assigned in step S103.

If the determination in step S101 is “YES”, the processor 51 executes the processes of step S104 and step S105, and then ends the pre-segment generation process. In step S104, the processor 51 executes labeling processing using a general lookup table. In step S105, the processor 51 generates pre-segment information. That is, one pre-segment PS is generated by ranging points P to which the same label is assigned. Then, information such as a position, a size, and a speed is given to each pre-segment PS. The pre-segment generation processing as described above is substantially the same as a clustering or grouping method based on position information and speed information. Therefore, further details of the pre-segment generation process will be omitted in the present specification.

The processor 51 reads the target recognition program (that is, a program including the radar signal processing program) according to the present embodiment from the memory 52 and executes the target recognition program to perform the segment generation process illustrated in FIG. 7. In the segment generation processing, first, in step S201, the processor 51 determines whether all the pre-segments PS have been selected as the target pre-segment. When the determination in step S201 is “NO”, the processor 51 selects the pre-segment PS that has not been selected as the target pre-segment as the current target pre-segment, and then proceeds the process to step S202.

In step S202, the processor 51 determines whether the target pre-segment is in a moving state that is, whether the target pre-segment corresponds to a moving target. When the determination in step S202 is “NO”, the processor 51 returns the processing to step S201. On the other hand, when the determination in step S202 is “NO”, the processor 51 proceeds the processing to step S203. In step S203, the processor 51 determines whether all the pre-segments PS other than the pre-segment selected as the target pre-segment this time have been selected as the reference segments. When the determination in step S203 is “YES”, the processor 51 returns the processing to step S201. Contrary to this, when the determination in step S203 is “NO”, the processor 51 selects the pre-segment PS that has not yet been selected as the reference pre-segment as the current reference pre-segment, and then proceeds the processing to step S204.

In step S204, the processor 51 determines whether a connection condition is satisfied. The “connection condition” means that all of the following first to third conditions are satisfied.

First condition: the size of the reference pre-segment is within the threshold.

Second condition: The target pre-segment and the reference pre-segment are close to each other (that is, the distance is within the threshold).

Third condition: the ranging points P of the reference pre-segment are present below the ranging points P constituting the target pre-segment.

When the determination in step S204 is “YES”, the processor 51 proceeds the processing to step S205. In step S205, the processor 51 assigns the same label to the target pre-segment and the reference pre-segment, and updates the lookup table. That is, the processor 51 connects the target pre-segment and the reference pre-segment. Contrary to this, when the determination in step S204 is “NO”, the processor 51 returns the processing to step S203. In this case, the processor 51 does not connect the target pre-segment and the reference pre-segment.

When the determination in step S201 is “YES”, the processor 51 executes the processes of step S206 and step S207, and then ends the pre-segment generation process. In step S206, the processor 51 executes the labeling processing using a general lookup table. In step S207, the processor 51 generates segment information. That is, one segment SG is generated by the ranging points P included in the pre-segment PS to which the same label is assigned. Information such as a position, a size, and a speed is assigned to each segment SG.

According to this specific example, for example, a connection of the target pre-segment or the reference pre-segment in the other vehicle V as the moving target or the rubber pole R as the stationary target is determined as follows. In the following determination example, it is assumed that two pre-segments PS, that is, an upper pre-segment PS on an upper portion of the center and a lower pre-segment PS on a lower portion of the center are recognized in the wheel Vt.
<1>Target pre-segment=Vehicle body VB: Movement
Reference pre-segment=Upper portion of wheel Vt: Movement

Since the ranging point P constituting the reference pre-segment is present directly below the ranging point P constituting the target pre-segment, the ranging point P constituting the target pre-segment and the ranging point P constituting the reference pre-segment are connected to each other.
<2>Target pre-segment=Vehicle body VB: Movement
Reference pre-segment=Lower portion of wheel Vt: Stationary

Since there is no ranging point P constituting the reference pre-segment directly below the ranging point P constituting the target pre-segment, the two are not connected.

However, as described in <3> below, since the lower portion of the wheel Vt is connected to the upper portion of the wheel Vt located immediately above the lower portion, as a result, the lower portion of the wheel Vt can also be integrated with the vehicle body Vb via the upper portion of the wheel Vt.
<3>Target pre-segment=Upper portion of wheel Vt: Movement
Reference pre-segment=Lower portion of wheel Vt: Stationary

Since the ranging point P constituting the reference pre-segment is present immediately below the ranging point P constituting the target pre-segment, both are connected.
<4>Target pre-segment=Upper portion of wheel Vt: Movement

Reference pre-segment=Rubber pole R: Stationary

Since there is no ranging point P constituting the reference pre-segment directly below the ranging point P constituting the target pre-segment, both are not connected.

### Modifications

The present invention is not limited to the embodiments and the examples described above. Therefore, the above embodiments can be appropriately changed. Hereinafter, typical modifications will be described. In the following description of the modifications, differences from the above embodiments will be mainly described. In the above embodiments and the following modifications, the same reference numerals are assigned to the same or equivalent parts. Therefore, in the following description of the modifications, the description in the above embodiments can be appropriately incorporated for the components having the same reference numerals as those in the above embodiments, unless there is a technical contradiction or a special additional description.

The present invention is not limited to the specific apparatus configuration described in the above embodiment. For example, the application target of the present invention is not limited to a vehicle traveling on a road or the like. The radar sensor 2 may have a configuration other than the laser radar sensor. That is, for example, the radar sensor 2 may be a millimeter wave radar sensor.

Each functional configuration unit illustrated in FIG. 2 is merely for convenience of simplifying the description of the embodiment of the present invention. Therefore, the illustration in FIG. 2 does not mean that these functional components need to be implemented as some modules or hardware in the target recognition device 5.

The program according to the present embodiments capable of performing various operations, procedures, or processing described in the above embodiments can be downloaded or upgraded via V2X communication. V2X is an abbreviation for Vehicle to X. Alternatively, such a program can be downloaded or upgraded via terminal equipment provided in a manufacturing factory, a maintenance factory, a shop, or the like of a vehicle. The program may be stored in a memory card, an optical disk, a magnetic disk, or the like.

As described above, each functional configuration, processes and method described above may be implemented by a dedicated computer provided by configuring a processor and a memory programmed to execute one or a plurality of functions embodied by a computer program. Alternatively, each functional configuration, processes and method described above may be implemented by a dedicated computer provided by configuring a processor with one or more dedicated hardware logic circuits. Alternatively, each functional configuration, processes and method described above may be implemented by one or more dedicated computers configured with a combination of a processor and a memory programmed to execute one or a plurality of functions and a processor configured with one or more hardware logic circuits. The computer program may be stored in a computer-readable non-transitory tangible storage medium as an instruction to be executed by the computer. That is, each functional configuration, processes and method described above can also be expressed as a computer program including procedures for implementing the functional configuration and method, or a non-transitory tangible storage medium storing the program.

The present invention is not limited to the specific operation modes shown in the above embodiments. That is, for example, “within a threshold” and “less than a threshold” are interchangeable. The same applies to “equal to or greater than a threshold” and “exceeding a threshold”. In addition, in FIG. 5, the pre-segments PS included in the segment SG which is a composite segment may be eliminated. That is, the composite segment may be formed by connecting or integrating the pre-segments PS. In addition, since the speed information of the reference pre-segment is not taken into consideration when the information of the reference pre-segment is added to the target pre-segment, the micro-Doppler point can be accurately excluded when the speed information of the target is calculated, and the accuracy of the speed information can be improved.

In the above embodiment, the condition for generating the composite segment from the target pre-segment and the reference pre-segment includes that the target pre-segment is composed of the ranging points P corresponding to the moving target. Contrary to this, modifications are possible. That is, such a condition may include, for example, a condition that both the target pre-segment and the reference pre-segment include the ranging points P corresponding to the moving target. That is, a condition that the reference pre-segment includes the ranging points P corresponding to the moving target may be added to the connection condition. In this case, in FIG. 7, a step of determining whether the reference pre-segment is in a moving state (that is, whether the reference pre-segment corresponds to a moving target) is added between step S203 and step S204. When the determination is “YES”, the process proceeds to step S204, and when the determination is “NO”, the process returns to step S203. As a result, the erroneous integral detection of the stationary target and the moving target can be effectively reduced.

As shown in FIG. 8, there may be a case where the vehicle body Vb does not exist above the wheel Vt which is a rear wheel. In such a case, since the pre-segment PS corresponding to the vehicle body Vb and the ranging point P do not exist above the pre-segment PS corresponding to the wheel Vt which is the rear wheel, there is a possibility that the excessive division cannot be reduced according to the above embodiment.

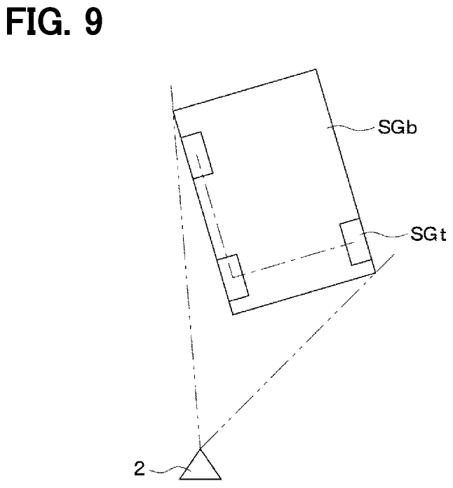

Therefore, in such a case, the connection with the vehicle body segment SGb can be performed using the positional relationship between the wheel segments SGt in a bird's-eye view illustrated in FIG. 9. That is, in the bird's-eye view, in the case of a four-wheeled vehicle, when the positions of the wheels Vt are connected by straight lines, a rectangle is necessarily formed. Therefore, referring to FIG. 9, when the wheel segments SGt captured by the radar sensor 2 are connected by straight lines as indicated by dash-dot-dash lines in the FIG. 9, the straight lines should be at a right angle. The connection between the wheel segment SGt corresponding to the wheel Vt which is a front wheel and the wheel segment SGt corresponding to the wheel Vt which is the rear wheel, in which the ranging point P corresponding to the vehicle body Vb is present on the upper portion, is performed using such the relationship of the right angle. As a result, the wheel segment SGt corresponding to the wheel Vt which is the rear wheel is also connected to the vehicle body segment SGb, thereby making it possible to reduce excessive division. The wheel segments SGt connected to one another can be interpreted as the pre-segments PS.

The modifications are also not necessarily limited to the above examples. A plurality of modifications may be combined with each other. Furthermore, all or a part of the above-described embodiments and all or a part of the modifications may be combined with each other.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radar signal processing device comprising:
an acquirer configured to acquire ranging point information including position information and speed information at each of ranging points obtained by irradiating radar waves;
a pre-segment generator configured to generate a pre-segment by grouping the ranging points as a set of the ranging points based on the acquired ranging point information from the acquirer; and
a segment generator configured to generate a composite segment by combining the ranging points from a first pre-segment with the ranging points from a second pre-segment as a set of the ranging points based on a positional relationship between the first pre-segment and the second pre-segment, the first pre-segment being one of pre-segments generated by the pre-segment generator, and the second pre-segment being another one of the pre-segments generated by the pre-segment generator.

2. The radar signal processing device according to claim 1, wherein
the segment generator is configured to generate the composite segment when the first pre-segment is composed of ranging points corresponding to a moving target.

3. The radar signal processing device according to claim 1, wherein
the segment generator is configured to generate the composite segment when a distance between the first pre-segment and the second pre-segment is within a threshold and when the ranging points included in the first pre-segment and the ranging points included in the second pre-segment are in a vertical relationship.

4. The radar signal processing device according to claim 1, wherein
the segment generator is configured to generate the composite segment when the first pre-segment surrounds the second pre-segment.

5. The radar signal processing device according to claim 1, wherein
the segment generator is configured to generate the composite segment when a size of the second pre-segment is within a threshold.

6. A radar signal processing method executed by a radar signal processing device, comprising:
acquiring ranging point information including position information and speed information at each of ranging points obtained by irradiating radar waves;
generating a pre-segment by grouping the ranging points as a set of the ranging points based on the acquired ranging point information; and
generating a composite segment by combining the ranging points from a first pre-segment and a second pre-segment as a set of the ranging points based on a positional relationship between the first pre-segment and the second pre-segment, the first pre-segment being one of pre-segments generated by the pre-segment generator, and the second pre-segment being another one of the pre-segments generated.

7. The radar signal processing method according to claim 6, wherein
the composite segment is generated when the first pre-segment is composed ranging points corresponding to a moving target.

8. The radar signal processing method according to claim 6, wherein
the composite segment is generated when a distance between the first pre-segment and the second pre-segment is within a threshold and the ranging points included in the first pre-segment and the ranging points included in the second pre-segment are in a vertical relationship.

9. The radar signal processing method according to claim 6, wherein
the composite segment is generated when the first pre-segment surrounds the second pre-segment.

10. The radar signal processing method according to claim 6, wherein
the composite segment is generated when a size of the second pre-segment is within a threshold.

11. A non-transitory computer readable storage medium storing a computer program comprising instructions configured to, when executed by a processor, cause the processor to:
acquire ranging point information including position information and speed information at each of ranging points obtained by irradiating radar waves;
generate a pre-segment by grouping the ranging points as a set of the ranging points based on the acquired ranging point information; and
generate a composite segment by combining the ranging points from a first pre-segment and a second pre-segment as a set of the ranging points based on a positional relationship between the first pre-segment and the second pre-segment, the first pre-segment being one of pre-segments generated by the pre-segment generator, and the second pre-segment being another one of the pre-segments generated.

12. The non-transitory computer readable storage medium according to claim 11, wherein
the composite segment is generated when the first pre-segment is composed ranging points corresponding to a moving target.

13. The non-transitory computer readable storage medium according to claim 11, wherein
the composite segment is generated when a distance between the first pre-segment and the second pre-segment is within a threshold and the ranging points included in the first pre-segment and the ranging points included in the second pre-segment are in a vertical relationship.

14. The non-transitory computer readable storage medium according to claim 11, wherein
the composite segment is generated when the first pre-segment surrounds the second pre-segment.

15. The non-transitory computer readable storage medium according to claim 11, wherein
the composite segment is generated when a size of the second pre-segment is within a threshold.
